(19) United States
(12) Patent Application Publication
(10) Pub. No.: US 2006/0210389 A1
(43) Pub. Date: Sep. 21, 2006

(54) Wind powered turbine

(76) Inventors: Andre St-Germain, St. Bonaventure (CA); Raymond Sigouin, Val-David (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/377,544

(22) Filed: Mar. 17, 2006

Related U.S. Application Data
(60) Provisional application No. 60/662,379, filed on Mar. 17, 2005.

(51) Int. Cl. F03D 7/06

(52) U.S. Cl. 415/4.2

(57) ABSTRACT

A blade for use with a vertical-axis wind turbine rotates about a vertical axis thereof along a circular blade path of travel. The blade includes a structural frame connecting to a blade support member of the wind turbine and supports loads acting on the blade. A semi-rigid skin at least partially covers the structural frame and connects thereto with a connector. The skin forms a longitudinally cross-section of the blade that has a water droplet shape-like contour defining a symmetry axis thereof, and extends between a wide convex leading edge of the blade and a narrow trailing edge thereof. The present invention also refers to the wind turbine and to a wind turbine assembly.

### CROSS REFERENCE TO RELATED APPLICATIONS

Benefit of U.S. Provisional Application for patent Ser. No. 60/662,379, filed on Mar. 17, 2005, is hereby claimed.

### FIELD OF THE INVENTION

The present invention relates in general to power generators, more specifically to wind powered turbines for the supply of economical and environmentally safe fuel in the form of compressed air or electricity for industrial, commercial or residential use, and the blades used therefore.

### BACKGROUND OF THE INVENTION

While conventional wind-powered generators are generally favored for environmental reasons over other forms of energy providers such as hydro, fossil fuel, nuclear, etc. they do have certain drawbacks. Great numbers of them are required to produce cost-efficient energy thus requiring an intricate infrastructure to consolidate the energy harnessed as well as a sizeable landmass for their deployment. A secondary consideration these “wind farms” create is the visual pollution attendant in their multiplicity.

Typically, the profile of the blades generally used in vertical axis wind-powered generators is asymmetrical and is quite complex to manufacture and assemble, thereby increasing the production costs thereof. Also, wind-powered generators with relatively high revolution speeds require more complex and expensive structural analysis leading to stronger and generally heavier components or simply to more expensive components.

Furthermore, to prevent acceleration of the rotational speed of the blades under high winds, wind-powered generators typically include directional guiding system to follow the wind direction and/or blade angular adjustment mechanisms which add weight and complexity to the system.

Accordingly, there is a need for an improved wind powered turbine/with a simple blade configuration.

### SUMMARY OF THE INVENTION

It is therefore a general object of the present invention to provide an improved wind-driven power-generating device that obviates the above-noted disadvantages and can be provided in a varying degree of preferred embodiments to best suit the locale of utilization.

An advantage of the present invention is that the wind powered turbine includes a relatively simple blade configuration for relatively low revolution speed applications.

A further advantage of the present invention is that the wind powered turbine includes aerodynamically efficient blades having a longitudinally uniform cross-section with water droplet shape-like contour, and of relatively simple configuration for lightness and rigidity.

Another advantage of the present invention is that the wind powered turbine produces compressed air or electrical energy accrued through wind power is cheaply and easily stored in conventional containment systems for later consumption.

Another advantage of the present invention is that the wind powered turbine enables accumulation and storage of wind-generated energy produces little pollution and is largely independent of any external energy needs concerning its functioning.

A further advantage of the present invention is that the wind powered turbine requires less total landmass than do conventional wind farms and therefore produce more energy per square foot thus ensuring a more efficient use of available land for other uses and additionally reducing visual pollution.

Still another advantage of the present invention is that the wind powered turbine, in some embodiments, includes blade or foil surface areas can be printed upon or fiber-optically treated to serve as grounds (media) for promotional purposes (rotating billboards) in simple or technically sophisticated applications well known in the art.

Yet another advantage of the present invention is that the wind powered turbine includes features that slightly improve its efficiency relative to known wind powered turbines/generators.

Yet a further advantage of the present invention is that the wind powered turbine is free of any type of gear or the like, does not require any directional guiding system to follow the wind direction, does not include any blade angular adjustment, is almost free of maintenance, is permanently active and is environment friendly.

According to an aspect of the present invention, there is provided a blade for use with a vertical-axis wind turbine to rotate about a vertical axis of the wind turbine along a circular blade path of travel, said blade comprises: a structural frame for connecting to a blade support member of the wind turbine and supporting loads acting on said blade, thereby preserving structural integrity thereof; and a semi-rigid skin at least partially covering the structural frame and connecting thereto with a connector, said skin forming a generally longitudinally cross-section of the blade, said cross-section having a water droplet shape-like contour defining a symmetry axis thereof extending between a wide convex leading edge of said blade and a narrow trailing edge of said blade.

In one embodiment, the structural frame includes a longitudinal rod connectable to the blade support member and having a first connector portion longitudinally extending therealong, said skin having second connector portion inwardly protruding therefrom, said second connector portion mating with said first connector portion to connect said skin to said frame.

Typically, the first connector portion includes channels formed along said rod and said second connector portion includes longitudinal protrusions longitudinally slidably engaging corresponding said channels.

In one embodiment, the structural frame includes a longitudinal rod connectable to the blade support member and positioned adjacent said leading edge of said blade and a plurality of transverse ribs extending from said rod toward said trailing edge of said blade, said plurality of transverse ribs being spaced apart from one another, said skin connecting to said rod and said ribs.

Conveniently, the longitudinal rod substantially forms said leading edge of said blade.

In one embodiment, the blade further includes end plates located at longitudinal ends of said blade and connecting to said frame.

Conveniently, each said end plate substantially covers a respective longitudinal end of said frame and tapers outwardly away from said skin in a direction leading toward said trailing edge.

In one embodiment, the connector includes a plurality of fasteners connecting said skin to said structural frame; typically using rivets.

In one embodiment, the structural frame is connectable to the support member with said symmetry axis being angularly offset from a tangential direction of the blade path of travel with said trailing edge of said blade extending outwardly away therefrom.

Conveniently, the blade is angularly offset from said tangential direction of the blade path of travel by an offset angle being within a range between about minus twenty-five (25) degrees and about twenty-five (25) degrees.

In another aspect of the present invention, there is provided a vertical-axis wind turbine comprising a plurality of blades as described hereinabove connected to respective blade support members extending radially outwardly from a central shaft for rotation about a vertical axis thereof along a circular blade path of travel, said central shaft being connectable to a power generator.

In one embodiment, each said support member extends substantially radially and horizontally from said central shaft and connects to respective said frame structure at a position located substantially halfway between longitudinal ends of said blade.

Typically, each said support member includes a support arm with a passageway extending therealong and a safety cable extending within said passageway and connecting to said central shaft and to respective said blade.

In one embodiment, each said blade includes end plates located at longitudinal ends of said blade and connecting to said frame, each said support member including support sections connecting to respective said end plates of said blade.

Conveniently, each said end plate substantially covers a respective longitudinal end of said frame and tapers outwardly away from said skin in a direction leading toward trailing edge.

Typically, each said support member including support sections connecting to respective said end plates of said blade.

In a further aspect of the present invention, there is provided a multiple wind turbine assembly comprising a plurality of vertical-axis wind turbines as described hereinabove connected to respective pair of turbine support arms extending radially outwardly from an assembly main shaft for rotation about a vertical assembly main axis thereof along a circular turbine path of travel, each said central shaft having longitudinal ends thereof rotatably connecting to respective said pair of turbine support arms, said central shafts and said assembly main shaft being connectable to a power generator.

Conveniently, the assembly main shaft supports three of said turbines, and wherein each said turbine includes three of said blades.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a simplified perspective view showing a wind powered generator in accordance with an embodiment of the present invention usable in conjunction with any typical energy storage system;

FIG. 2 is a simplified perspective view of another embodiment of the present invention wherein the wind powered generator is self-sufficient and mainly used as an advertising tool;

FIG. 3 is a section view taken along line 3-3 of FIG. 2;

FIG. 4 is a simplified perspective view of another embodiment of the present invention wherein the device is comprised of three energy-gathering elements as seen in FIG. 1 circumferentially and equidistantly secured to a central rotating mast by means of upper and lower braces;

FIG. 4a is a view similar to FIG. 4 showing an alternate bracing system securing the wind blades to their individual peripheral masts;

FIG. 5 is a section view taken along line 5-5 of FIG. 4;

FIG. 6 is a simplified exploded perspective view taken along line 6 of FIG. 4;

FIG. 7 is a section view taken along line 7-7 of FIG. 4a;

FIG. 8 is a simplified perspective view of another wind blade in accordance with an embodiment of the present invention;

FIG. 9 is a section view taken along line 9-9 of FIG. 8;

FIG. 10 is an enlarged broken section view taken along line 10-10 of FIG. 4a;

FIG. 11 is a simplified perspective view of another wind blade in accordance with an embodiment of the present invention; and

FIG. 12 is a section view taken along line 12-12 of FIG. 11.

### DETAILED DESCRIPTION OF THE PREFERRED EMBODIMENTS

With reference to the annexed drawings the preferred embodiments of the present invention will be herein described for indicative purpose and by no means as of limitation.

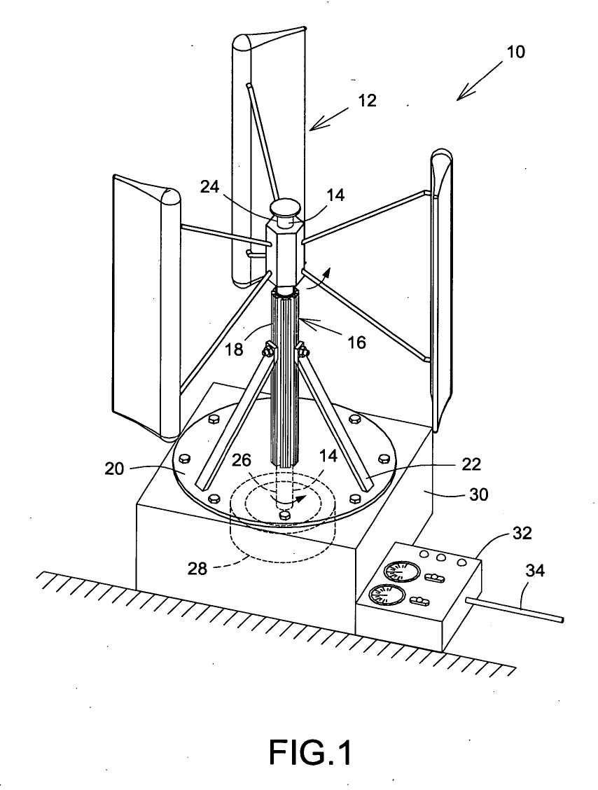

FIG. 1 shows a vertical-axis wind powered generator or turbine 10 in accordance with an embodiment of the present invention that includes a wind blade assembly 12 mounted on a vertical shaft 14 rotatably supported by a supporting structure 16. Typically, the supporting structure 16 includes a central mast or shaft 18 secured on a base 20 via braces 22. The upper longitudinal end 24 of the shaft 14 is rotatably driven by the blade assembly 12. The wind power is then transferred to the lower longitudinal end 26 of the shaft 14 that is operatively connected to an air pump 28 or the like compressor or any other electrical power generator typically located below a mounting structure 30 that supports the turbine 10 to generate compressed air that is directed to a regulator-controller 32 or the like to either be directly used to power any equipment or tool (not shown) via a connecting hose 34 or stored in nearby storage units or tanks (not shown), preferably located underground, via a dedicated connecting hose (not shown) for future use, or stored in readily interchangeable tanks (not shown) for use in vehicles or the like. Furthermore, as it would be obvious to one skilled in the art, the wind powered turbine 10 could be operatively connected to an electrical generator or the like to produce electrical energy depending on the local needs, without departing from the scope of the present invention.

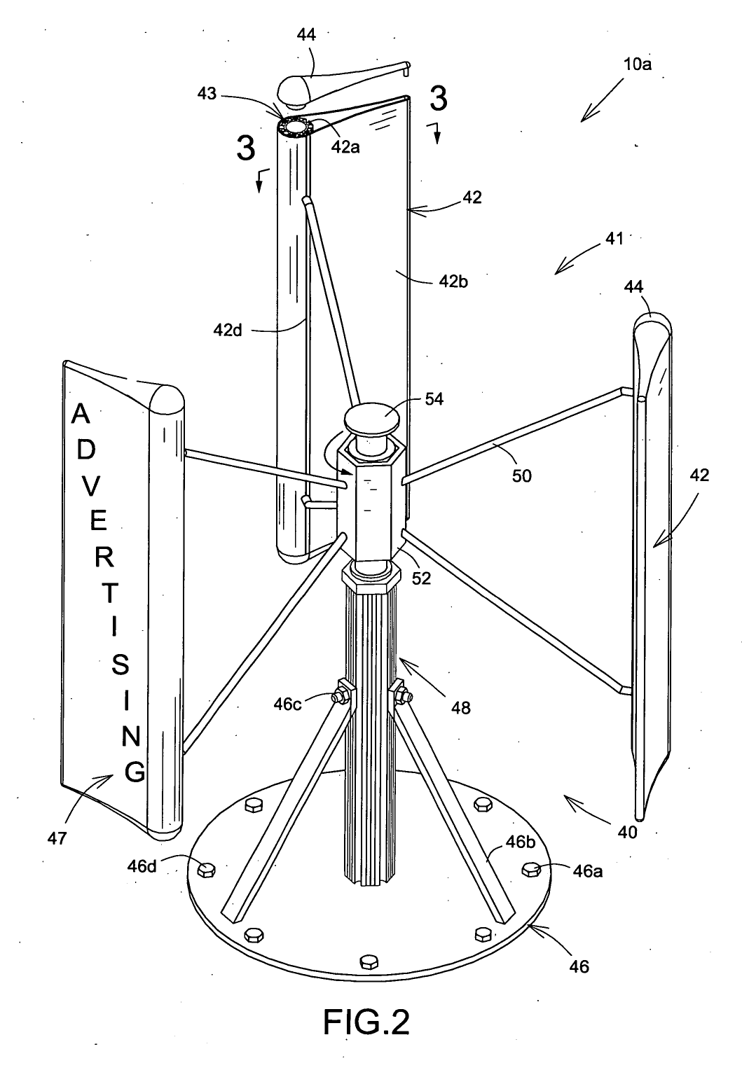

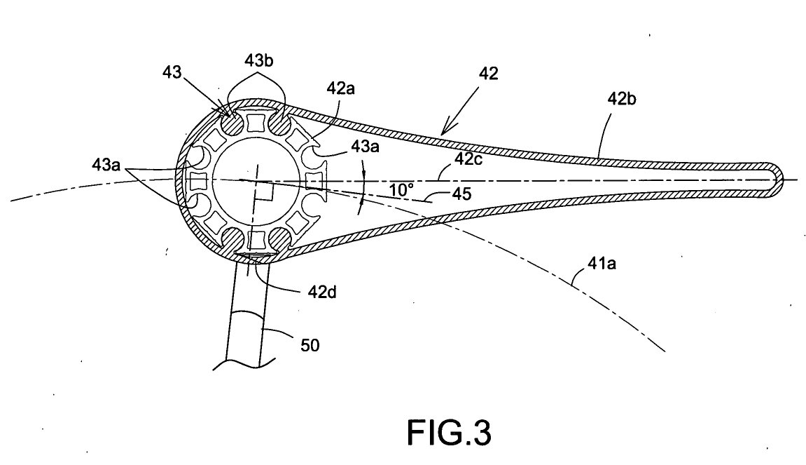

FIG. 2 shows a more ‘standalone’ embodiment 10a of a wind turbine 40 in accordance with the present invention that is comprised of three basic elements being the mast 48 and base plate 46 assembly and the wind blade assembly 41. The base plate assembly 46 is comprised of a typically circular base plate 46a, three braces 46b that are welded to the base plate 46b and in turn fastened to the central mast or shaft 48 with conventional mast fasteners 46c (nut and bolt). The base assembly 46a is secured to a ground surface such as a building rooftop or the like with base plate fasteners 46d of a type most suited to the ground surface provided and also well known in the art. Also depicted in FIG. 2 is the wind blade assembly 41 which is comprised of a rotating generator housing 52 which is situated on top of the mast 48 and houses a conventional electrical generator (not shown) and which provides wind derived energy to an energy storage unit (not shown) such as a battery located on the rotating section of the turbine 10a. The rotating generator housing 52 also supports blade support members, such as six blade support struts 50 that are equidistantly located around the exterior thereof and serve to support three wind blades 42 whose function is to rotationally move around the mast 48 along a circular blade path of travel 41a under driving winds to collect energy therefrom. The wind blade 42 is typically comprised of a structural frame that includes a wind blade longitudinal rod 42a which is typically located adjacent to and preferably serves as the leading edge of the wind blade 42 and is typically composed of an extruded and multi-channeled aluminum rod (see FIG. 3); a semi-rigid blade skin 42b typically composed of light weight pre-molded plastic, metallic or the like material which is slidably and vertically mounted on longitudinal channels of the wind blade rod 42a and secured in place by wind blade end plates or caps 44 which are frictionally fitted to both the upper and lower extremities of the wind blade 42. The skin 42b forms a generally longitudinally, typically uniform, cross-section of the blade that has an aerodynamically efficient water droplet shape-like contour defining a symmetry axis 42c thereof extending between a relatively wide convex leading edge of the blade 42 and a relatively narrow trailing edge of the blade 42, as shown in FIG. 3. The wind blade assembly 41 is releasably secured to the stator section of the electrical generator mounted on the mast 48 with a mast cap 54 releasably attached thereto.

FIG. 3 is a detailed section of a wind blade 42 of the present invention showing a structural frame formed a tubular longitudinally channeled aluminum wind blade rod or shaft 42a with attendant longitudinal wind blade channels 43a. Also shown is the wind blade skin 42b which is typically composed of a semi-rigid and thin durable light weight pre-molded plastic material connected to the rod 42a via a connector 43. The skin 42b is provided with longitudinal protrusions 43b along the length of the internal surface of the leading edge segment of the wind blade skin 42b that form a second connector portion for connection to the first connector portion of the frame, namely the channels 43a. The longitudinal protrusions 43b are intended to serve functionally as . . . a locking/securing element when it is inserted slidable and vertically into the corresponding wind blade channels 43a of the wind blade rod 42a. The structural frame 42a is connected to the support struts 50 with the blade symmetry plane or blade section symmetry axis 42c being angularly offset from a tangential direction 45 of the blade path of travel 41a with the trailing edge of said blade extending outwardly away therefrom. This offset angle (or angle of attack) is typically within a range between about minus twenty-five (−25) degrees and about twenty-five (25) degrees, and is preferably about zero (0) degree.

Typically, the skin 42b includes a longitudinal cut 42d to ease its installation and/or removal, as well as its manufacturing, over the rod 42a. At the cut 42d location, the skin edge coming from the leading edge of the blade 42 typically overlaps the skin edge coming from the trailing edge to ensure proper aerodynamic stability of the blade 42 and prevent accidental removal of the skin 42b during operation of the turbine, as shown in FIGS. 2 and 3.

From the above description, it is obvious that the blade skin 42b is relatively easily interchangeable. This allows the embodiment of FIGS. 2 and 3 to be especially suitable for advertising applications in which the blade skins 42b could be covered with advertising signs 47 or the like. Although not specifically illustrated, some neon or other suitable lighting equipment could easily be carried by the blades 42 and powered by the electrical generator driven by the wind turbine 10a. For example, the neon could be located inside the blade skin 42b that would be at least partially transparent. Such illuminated and ‘moving’ ads could be particularly attractive at night for business owners and the like. Similarly, the internal side of the blades 42 facing the mast 48 could also be covered with flexible type solar panels (not shown) to collect energy from the Sun during daytime, if required.

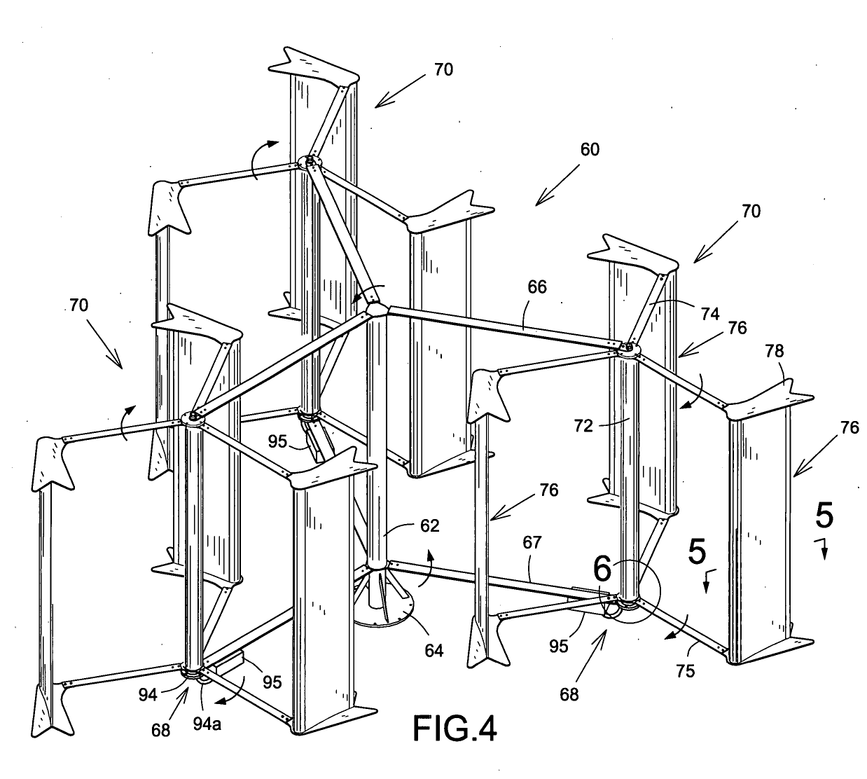

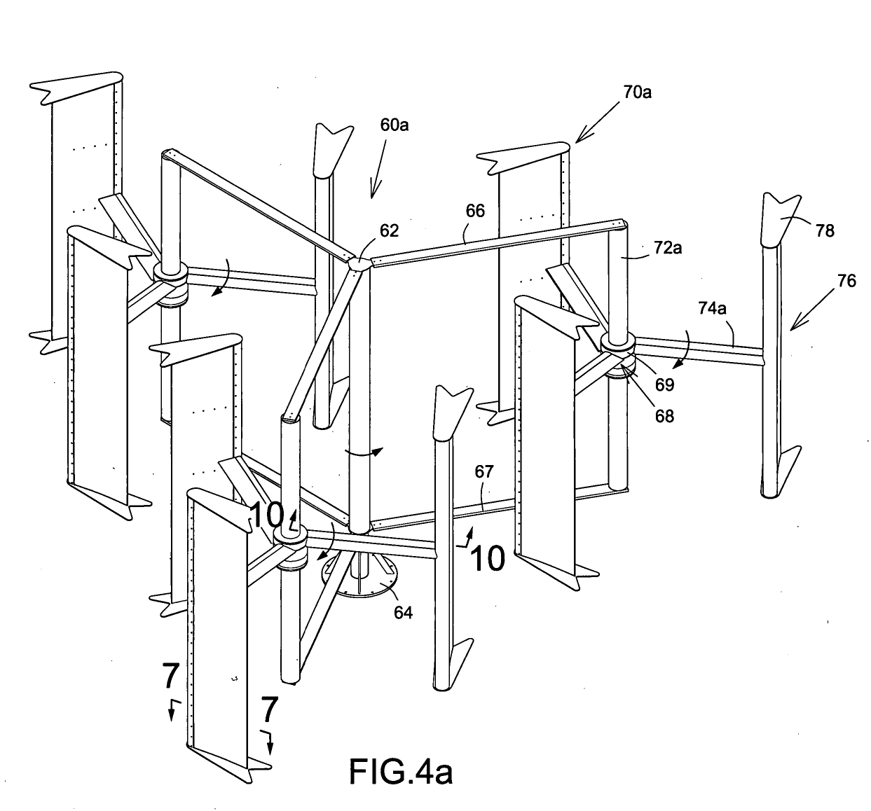

FIG. 4 depicts another embodiment 60 of the present invention being essentially an extended application of the functioning elements, as described in FIG. 1, and some details in FIGS. 2 and 3, some of said elements being slightly modified; the apparatus illustrated being a multiple wind turbine assembly 60 comprised of a central assembly main mast or shaft 62 supported by a base plate assembly 64. Extending laterally from the upper and lower ends of the main assembly mast 62 are depicted three upper blade assembly or turbine support struts or arms 66 and three lower turbine support struts or arms 67 whose function is to rotatably support three generally equidistantly circumferentially spaced wind blade turbine assemblies 70 and provide a rotational ability both from the main assembly central mast 62 and the peripheral secondary central shafts 72. Each said wind turbine assemblies 70 is comprised of three generally equidistantly circumferentially spaced wind blades 76 connected to a peripheral shaft 72 by three upper blade support struts 74 and three lower blade support struts 75. Compressed air compressor/regulator or other power generator assemblies 68 are indicated at the base of the three lower blade assembly support struts 67 corresponding to respective wind turbine assembly 70. Also depicted at the upper and lower extremities of each wind blade 76 are drag spoilers 78 or blade end plates whose function is to reduce vortex-related drag at the longitudinal end edges of the wind blade 76 while in motion, thus increasing the turbine efficiency. More specifically, each end plate 78 substantially covers a respective longitudinal end of the blade frame and tapers outwardly away from the skin 42b in a direction leading toward the trailing edge of the blade 76. The three peripheral masts 72 are allowed to rotate about the main assembly central mast 62 into a precession thereof due to the resistive torque induced by the three power generator assemblies 68. This precession improves the overall efficiency of the multiple wind turbine assembly 60 as opposed to prevent rotation thereof. It should be noted that there is preferably no power generator assembly 68 at the base of the main assembly central mast 62 as such an inclusion would prove counter-productive in the accumulation and storage of wind-derived energy given the physical characteristics inherent in the functioning of the mechanism as a whole.

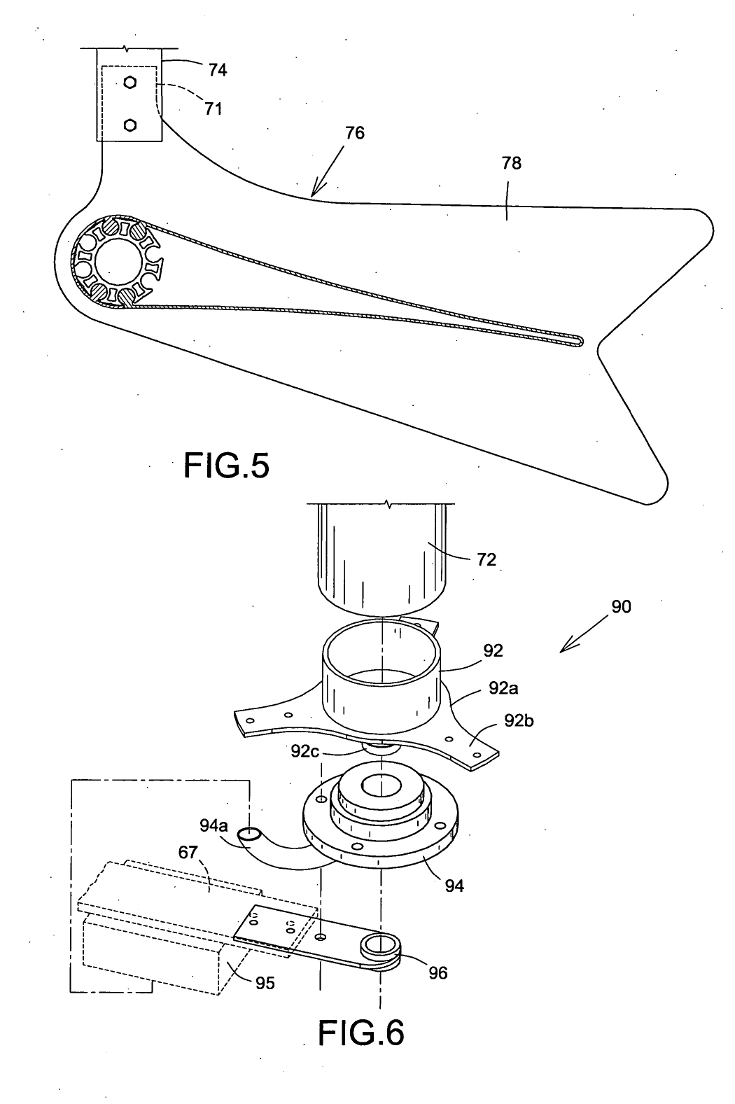

FIG. 5 shows a blade support member or strut coupling 71 located at the leading inside edge of a drag spoiler 78, the strut coupling 71 being a configural modification of said drag spoiler 78 in that it extends outwardly and laterally thus distorting the aerodynamic configuration of said drag spoiler 78 to serve as a means of connecting the frame of the blade 76 to the upper 74 and lower 75 blade support struts.

FIG. 6 shows the peripheral mast 72 as it relates to the air compression unit 90 itself or the like which includes a rotating coupling bracket 92 having a base 92a with three equidistantly spaced support flanges 92b connectable to respective lower blade support struts 75 to allow the rotatable element 92c to operatively couple to the non-rotating compressor base 94 of the lower portion of the air compressor unit 90. The compressor base 94 configured to operatively accommodate the compressor rotatable element 92c and is additionally provided with an air exhaust hose 94a which extends therefrom to connect with the compressed air regulator unit 95 mounted on the respective lower turbine support strut 67. The rotating coupling bracket 92 is mounted on the peripheral mast 72 while the compressor base 94 is attached to the respective lower turbine support strut 67 via a compressor support bracket 96.

Although not shown, the compressed air generated by the three alternator/compressor assemblies 68 could be directed to a common storage unit or the like (see FIG. 1) located nearby the multiple wind turbine assembly 60, via hose couplings and the like well known in the art, including a conventional endless pneumatic rotary coupling (not shown) between the rotating central mast 62 and its supporting base plate assembly 64.

FIG. 4a is another embodiment 60a slightly modified from the embodiment 60 of FIG. 4, the variation residing in the relocation of the blade support struts 74a to be now substantially aerodynamically profiled and longitudinally centrally positioned along the peripheral mast 72 that is fixedly attached to the respective upper and lower turbine support struts 66, 67, and halfway between the longitudinal ends of the blades 76. An additional variation is the relocation of the alternator/compressor assemblies 68 within the blade support hub 69 of the peripheral mast 72.

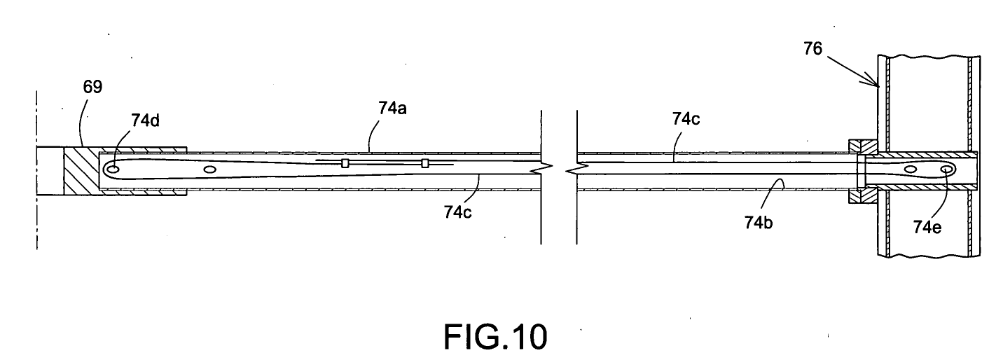

As shown in FIG. 10, and mainly for safety and security purposes, each blade support strut 74a includes a passageway 74b that extends there along and a safety cable 74c which extends within the passageway 74b and slightly loosely connects to structural pins or the like 74d, 74e connected to the hub 69 of the peripheral shaft 72 and to the frame of the blade 76, respectively. The cable 74c would prevent the blade 76 from flying away from the peripheral mast 72 in case of failure of the blade support strut 74a, or the connections thereof.

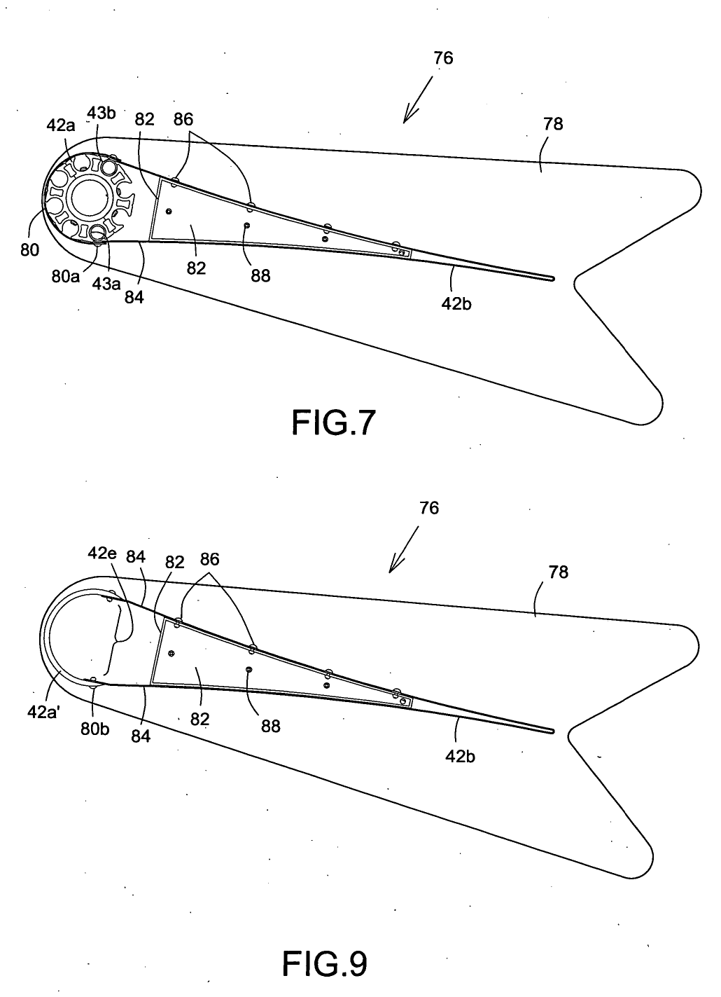

FIGS. 7, 9, and 12 represent variations in construction of the wind blade 76 of the embodiments of FIGS. 4a, 8 and 11 respectively, to suit larger installations or more rigorous wind-related eventualities.

FIG. 7 depicts the wind blade rod 42a and blade skin 42b respectively frontally and partially overlapped by a leading edge collar 80 skin portion comprised of a light weight metal or plastic material and secured in place by connector fasteners such as collar rivets 80a. The rivets 80a typically simultaneously secure both blade skin 42b and leading edge collar 80 to the wind blade shaft 42a through the wind blade channel(s) 43. An additional structurally integral modification to the wind blade 76 is the inclusion of a plurality of transversal (or horizontal) ribs 82 to the structural frame of the blade 76. The series of five (5) generally equidistantly spaced blade ribs 82 are secured in place to the blade skin 42b by rivets 86 or the like and laterally maintained aligned to each other along the interior length of the blade 76 by four (4) rib guiding bars 88 extending there through. Although not shown, the ribs 82 could also be connected to the shaft 42a.

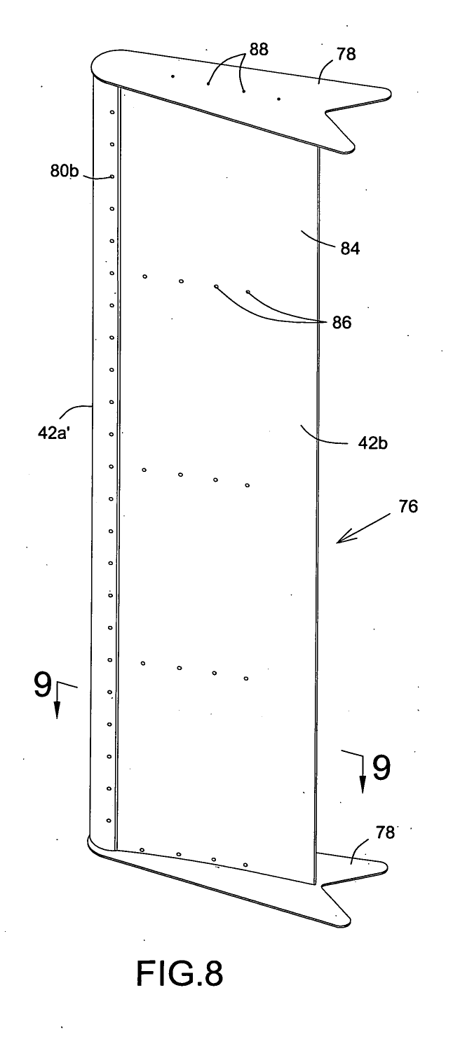

FIGS. 8 and 9 show another embodiment of the wind blade 76 that includes a substantially rigid leading edge collar rod 42a′ or channeled tube with C-shaped section in replacement of both the blade shaft 42a and the leading edge collar 80. The blade skin 42b is secured to the leading edge collar post 42a′ with collar rivets 80b. The collar rod 42a′ has a longitudinal opening 42e generally facing the trailing edge of the blade 76 and closed by the skin 42b. Additional structural variations are as seen and described in FIG. 7.

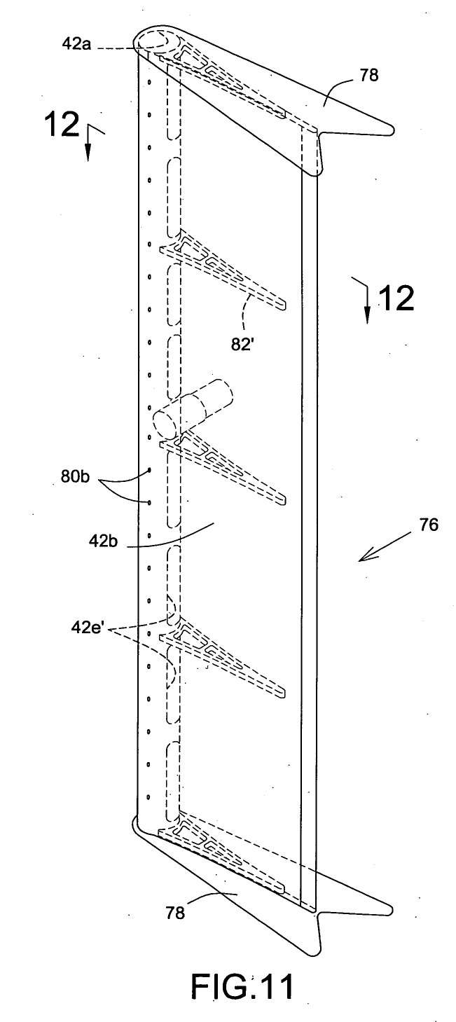

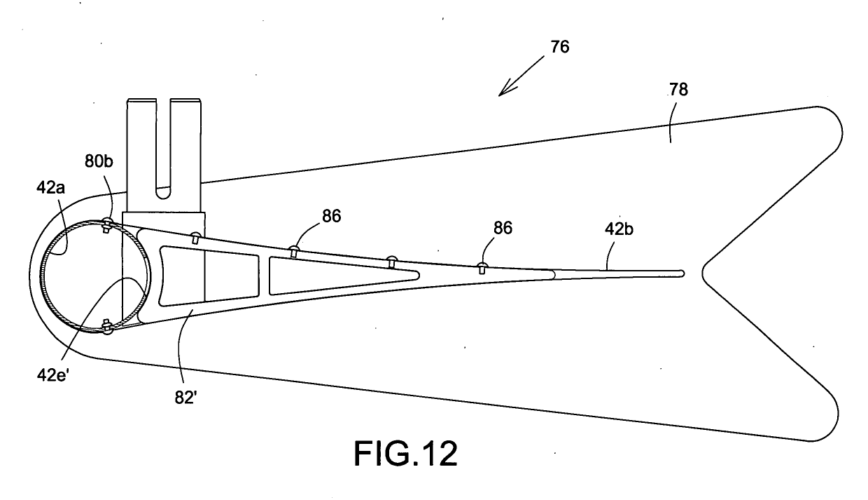

FIGS. 11 and 12 show a further embodiment of the wind blade 76 that includes a substantially rigid leading edge rod 42a or channeled tube with a plurality of slot openings 42e′ generally facing the trailing edge of the blade 76 essentially for mass reduction purposes. The blade skin 42b is secured to the leading edge rod 42a and to the ribs 82′ with rivets 80b and 86 respectively.

Although not shown or even discussed hereinabove, brake mechanisms, automatic and/or manual, as well as speed controllers are provided with the wind powered generators to control operation thereof. Furthermore, electronic sensors and/or controls well known in the art may be used in conjunction with the present invention to improve control thereof, it being remote or not.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1. A blade for use with a vertical-axis wind turbine to rotate about a vertical axis of the wind turbine along a circular blade path of travel, said blade comprising:
a structural frame for connecting to a blade support member of the wind turbine and supporting loads acting on said blade, thereby preserving structural integrity thereof; and
a semi-rigid skin at least partially covering the structural frame and connecting thereto with a connector, said skin forming a generally longitudinally cross-section of the blade, said cross-section having a water droplet shape-like contour defining a symmetry axis thereof extending between a wide convex leading edge of said blade and a narrow trailing edge of said blade.

2. The blade of claim 1, wherein said structural frame includes a longitudinal rod connectable to the blade support member and having a first connector portion longitudinally extending therealong, said skin having second connector portion inwardly protruding therefrom, said second connector portion mating with said first connector portion to connect said skin to said frame.

3. The blade of claim 2, wherein said first connector portion includes channels formed along said rod and said second connector portion includes longitudinal protrusions longitudinally slidably engaging corresponding said channels.

4. The blade of claim 1, wherein said structural frame includes a longitudinal rod connectable to the blade support member and positioned adjacent said leading edge of said blade and a plurality of transverse ribs extending from said rod toward said trailing edge of said blade, said plurality of transverse ribs being spaced apart from one another, said skin connecting to said rod and said ribs.

5. The blade of claim 1, wherein said longitudinal rod substantially forms said leading edge of said blade.

6. The blade of claim 1, further including end plates located at longitudinal ends of said blade and connecting to said frame.

7. The blade of claim 6, wherein each said end plate substantially covers a respective longitudinal end of said frame and tapers outwardly away from said skin in a direction leading toward said trailing edge.

8. The blade of claim 1, wherein said connector includes a plurality of fasteners connecting said skin to said structural frame.

9. The blade of claim 8, wherein said fasteners are rivets.

10. The blade of claim 1, wherein said structural frame is connectable to the support member with said symmetry axis being angularly offset from a tangential direction of the blade path of travel with said trailing edge of said blade extending outwardly away therefrom.

11. The blade of claim 10, wherein said blade is angularly offset from said tangential direction of the blade path of travel by an offset angle being within a range between about minus twenty-five (25) degrees and about twenty-five (25) degrees.

12. The blade of claim 1, wherein said structural frame includes a longitudinal collar rod of a substantially C-shaped section forming said leading edge with an longitudinal opening facing said trailing edge, said skin substantially closing said opening when connected to said collar rod.

13. A vertical-axis wind turbine comprising a plurality of blades according to claim 1 connected to respective blade support members extending radially outwardly from a central shaft for rotation about a vertical axis thereof along a circular blade path of travel, said central shaft being connectable to a power generator.

14. The turbine of claim 13, wherein each said support member extends substantially radially and horizontally from said central shaft and connects to respective said frame structure at a position located substantially halfway between longitudinal ends of said blade.

15. The turbine of claim 14, wherein each said support member includes a support arm with a passageway extending therealong and a safety cable extending within said passageway and connecting to said central shaft and to respective said blade.

16. The turbine of claim 13, wherein each said blade includes end plates located at longitudinal ends of said blade and connecting to said frame, each said support member including support sections connecting to respective said end plates of said blade.

17. The turbine of claim 16, wherein each said end plate substantially covers a respective longitudinal end of said frame and tapers outwardly away from said skin in a direction leading toward trailing edge.

18. The turbine of claim 17, wherein each said support member including support sections connecting to respective said end plates of said blade.

19. A multiple wind turbine assembly comprising a plurality of vertical-axis wind turbines according to claim 13 connected to respective pair of turbine support arms extending radially outwardly from an assembly main shaft for rotation about a vertical assembly main axis thereof along a circular turbine path of travel, each said central shaft having longitudinal ends thereof rotatably connecting to respective said pair of turbine support arms, said central shafts and said assembly main shaft being connectable to a power generator.

20. The turbine assembly of claim 19, wherein said assembly main shaft supports three of said turbines, and wherein each said turbine includes three of said blades.

21. A multiple wind turbine assembly comprising a plurality of vertical-axis wind turbines including a plurality of blades connected to respective blade support members extending radially outwardly from a turbine central shaft for rotation about a vertical axis thereof along a circular blade path of travel, each said wind turbines being connected to respective pair of turbine support arms extending radially outwardly from an assembly main shaft for rotation about a vertical assembly main axis thereof along a circular turbine path of travel, each said turbine central shaft movably connecting to respective said pair of turbine support arms, said central shafts and said assembly main shaft being connectable to a power generator.

22. The turbine assembly of claim 21, wherein each said turbine central shaft has two opposed longitudinal central shaft ends, each said central shaft ends movably connecting to a respective said turbine support arms of each said pairs.

23. The turbine assembly of claim 21, wherein said assembly main shaft supports three of said turbines generally equally circumferentially spaced apart from one another.

24. The turbine assembly of claim 23, wherein each said turbine includes three of said blades generally equally circumferentially spaced apart from one another.
